(19) United States
(12) Patent Application Publication
(10) Pub. No.: US 2015/0150273 A1
(43) Pub. Date: Jun. 4, 2015

(54) ANTIMICROBIAL COMPOSITIONS WITHIN ANTIOXIDANT SOLUTIONS USED TO PROTECT WHOLE PROTEIN FOODS

(71) Applicant: FRASERMICH CORP., DEER PARK, NY (US)

(72) Inventors: Frank Monteleone, Deer Park, NY (US); Charles MONTELEONE, Elmont, NY (US)

(73) Assignee: FRASERMICH CORP., DEER PARK, NY (US)

(21) Appl. No.: 14/613,947

(22) Filed: Feb. 4, 2015

Related U.S. Application Data
(63) Continuation of application No. 13/407,038, filed on Feb. 28, 2012.
(60) Provisional application No. 61/447,442, filed on Feb. 28, 2011.

(51) Int. Cl. A23B 4/12; A23B 4/22; A01N 43/42; A01N 31/16; A01N 31/08; A01N 43/16; A23B 4/20; A01N 37/02

(52) U.S. Cl. CPC A23B 4/12; A23B 4/20; A23B 4/22; A01N 37/02; A01N 31/16; A01N 31/08; A01N 43/16; A01N 43/42; A23V 2002/00

(57) ABSTRACT

An antimicrobial composition within an antioxidant solution and used to protect whole protein food source is provided. The antimicrobial compound of the composition is selected preferably from a medium chain fatty acid (MCFA), a long chain fatty acid (LCFA), a phenolic acid, and derivatives or mixtures thereof, and has a pH between about 2 and 6. Antioxidant compounds for the composition are composed preferably from phenolic based compounds such as butylated hydroxyanisole (BHA), butylated hydroxytoluene (butylhydroxytoluene, BHT), propyl gallate (propyl 3,4,5-trihydroxybenzoate), tert-butylhydroquinone (TBHQ, tertiary butylhydroquinone), mixed tocopherols (tocopherols, Vitamin E), rosemary extract, oregano oil (origanum oil) and vegetable oil; other antioxidant compounds such as calcium propanoate (or calcium propionate) and ethyoxyquin; and derivatives or mixtures thereof.

This application is a continuation of U.S. Ser. No. 13/407,038 filed Feb. 28, 2012, which in turn is based on and claims priority of Provisional Application No. 61/447,442, filed Feb. 28, 2011.

### FIELD OF THE INVENTION

The composition of an antioxidant including an antimicrobial solution, the process of its preparation, and methods of use is provided. The invention relates to an antimicrobial application on whole protein food sources, especially those derived from poultry, beef, and swine, which are treated with a phenolic antioxidant for the purpose of stabilizing oxidative deterioration of whole protein foods. The invention intends to deliver antimicrobial compounds diluted within the phenolic antioxidant solution, improving the effectiveness and distribution of the antimicrobial compound upon the whole protein food source, and protecting the whole protein food source from pathogenic bacteria during the process of stabilizing oxidative degradation.

### BACKGROUND OF THE INVENTION

### A. Definitions

Whole proteins (also known as complete proteins or high quality proteins) contain all the essential amino acids in amounts necessary for the diets of humans or animals. Eight amino acids are generally regarded as essential: phenylalanine, valine, threonine, tryptophan, isoleucine, methionine, leucine, and lysine. Generally, proteins derived from animal foods (meats, fish, poultry, cheese, eggs, yogurt, and milk) are classified as whole proteins. See Vaughan, et al., “The New Oxford book of food plants” Oxford University Press 215 (2009); National Research Council (U.S.). “Committee on Technological Options to Improve the Nutritional Attributes of Animal Products” National Academies Press 22-23 (1988); D'Mello, J. P. Felix “Amino acids in animal nutrition” CABI 16-20 (2003).

Antioxidants are substances used in food preservation for the purpose of defending the protein or food source from oxidative degradation of polyunsaturated fatty acids. Fatty acid oxidation is a complex process of chemical and biological reactions leading to formation of a large number of products, including changes in taste and aroma, changes in the proteins structure due to the reaction with products derived from oxidation, and the subsequent loss in nutritional value due to the destruction of vitamins, amino acids, and essential fatty acids.

Antioxidants are applied to whole protein food sources to slow the oxidative process by which lipid oxidation reactions take place in foodstuffs. Antioxidants are categorized by the Food and Drug Administration as “substances used as preservatives, with the aim to reduce spoilage, rancidity, or food discoloration, which are derived from oxidations.”

Food antimicrobial agents are defined by the U.S. Food and Drug Administration (FDA) as “substances used to preserve food by preventing growth of microorganisms and subsequent spoilage, including fungistats, mold and rope inhibitors.

Mixed tocopherols are a class of organic chemical phenol antioxidant compounds of which many have vitamin E activity.

### B. Pathogenic Contamination of Protein Sources

The ability to eliminate food borne pathogens from animal food protein sources remains a difficult challenge for food manufacturers. Moreover, the challenge to eliminate pathogens from the human food source is linked to the ability to remove theses very same pathogens from diets fed to the animal food protein source. Eliminating the pathogen from the intestinal tract of the animal protein source, and thereby reducing the incidence of exposure to various pathogens in the gut flora during harvest, places a direct link between human food contamination, and animal feed contamination.

### C. Pathogenic Resistance to Antibiotics

Salmonella, because of its multiple serovar types, and the adaptation of the organism, remains one of the most dangerous sources of contamination in both human and animal feed. Salmonella enterica serovar type Typhimurium was identified to be highly resistant to antibiotic treatments. E. coli was found more likely to become resistant after exposure to low levels of antibiotics. See van der Horst, Michael, et al. “Microbial Drug Resistance” Volume 17, Number 2, 2011, Mary Ann Liebert, Inc. (2011).

### D. Adaptation of Bacteria to Oxidative Stress

Studies have concluded that many pathogens, including Salmonella and E. Coli, have mutated an adaptive gene response as a response to various stresses, including oxidative stress. Oxidative stress is eliminated in the presence of antioxidants, further providing that while antioxidants, once applied to a whole protein food source, preserve and slow the oxidation of those foods, antioxidants indirectly improve the environment for the expansion of pathogenic bacteria upon the same treated whole protein food source. Bacterial response to an environment lacking the application of antioxidants show that many organisms have an inherent adaptability to an environment of oxidative stress on the bacteria's host food protein. Studies of the effects of oxidative stress on bacteria, including E. coli and Salmonella, have identified a specific collection of genes, or regulons, under regulation by the same regulatory protein (oxyR regulating protein, soxRS regulating protein) that are responsible for bacterial adaptive response to oxidative stress. This defines the process why specific pathogenic strains, such as E. coli and Salmonella, expand more regularly in sources containing antioxidants than they would in protein sources lacking antioxidants. See Yousef, et al. “Microbial stress adaptation and food safety” CRC Press 225 (2005), Grune, et al. “Oxidants and antioxidant defense systems” Springer Science & Business 68 (2005), Myers, “Molecular biology and biotechnology: a comprehensive desk reference” Wiley-VCH, 286-287 (1995).

### E. Expansion of Bacterial Pathogens in Presence of Antioxidant

Phenolic antioxidants have no impact upon slowing the growth of pathogenic microbes and bacteria in protein-based food sources. The application of phenolic antioxidants to whole proteins to protect lipid auto oxidation indirectly contributes to the growth and expansion of gram negative bacteria that cause food borne illness. See, e.g., Decker, et al., “Antioxidants in Muscle Foods: Nutritional Strategies to Improve Quality” Wiley-IEEE, 2000(436-438); Ryser, et al., “Listeria, listeriosis, and food safety”, CRC Press, 180-181 (2007); Sallam, et al., “Antioxidant and antimicrobial effects of garlic in chicken sausage”, National Institute of Health publication (2007); Barberis, et al., “Food-Grade Antioxidants and Antimicrobials To Control Growth and Ochratoxin A Production by Aspergillus Section Nigri on Peanut Kernels”, Journal of Food Protection, (Aug. 1, 2010).

### F. Insolubility Between Antimicrobials and Antioxidants

Presently, the use and application of phenolic antioxidants and antimicrobial solutions are diverse in their delivery location, given the difficulty for phenolic antioxidants, which are typically insoluble in water, but soluble in oils, and antimicrobials, which are typically water soluble acids that are insoluble in oil, to work together to achieve the intended result of each compound. In some cases, the presence of an antimicrobial can diminish the performance of antioxidants. For example, the insolubility of phenolic in the lipid phase of medium solutions is a contributing factor of BHA (butylated hydroxyanisole) having reduced antioxidant properties in solutions within antimicrobial properties, reducing the effectiveness of both the phenolic antioxidant and antimicrobial.

### G. Pathogenic Bacteria within Oils and Lipids

Many pathogens can hide within lipids and fat sources, further protecting them from contact by water-based organic acids. Soybean oil apparently effectively protects contaminating Salmonella from destruction by environmental conditions, and in areas containing fat accumulation, “Salmonella cannot be easily eliminated”. Indeed, other researchers have observed that fats tend to protect Salmonella from environmental or physiological stresses. See Jones, F. T. “A review of practical Salmonella control measures in animal feed” Journal of Applied Poultry Research, J Appl Poult Res 2011 20:102-113; doi:10.3382/japr. 2010-0028.

### H. The Use of Formaldehyde to Treat Salmonella on Protein Sources in Animal Feeds

Some studies have demonstrated that formaldehyde gas is an effective method of controlling salmonella on protein feed sources. However, the time for the formaldehyde gas to reach efficacy throughout the feed, and contact the protein source, can take up to several hours. Since formaldehyde is slightly heavier than air, there is a question of containment and efficacy throughout the feed protein source. To overcome these issues, liquid formaldehyde is added to the feed sources in sufficient quantity to ensure continuous production of the formaldehyde vapors throughout the protein feed. See Wray, et al. “Salmonella in domestic animals” CABI, 295 (2000).

### I. Cellular Structure of Gram Negative Bacteria

In general, gram-positive bacteria, such as Listeria and Clostridium, have a single lipid bilayer (monoderms), whereas gram-negative bacteria, such as Salmonella, E. coli, and Legionella, have two (diderms). See Mahy, et al. “Desk Encyclopedia of General Virology” Academic Press 251 (2009).

### J. Fatty Acids Ability to Penetrate Gram Negative Cell Walls

The penetration of two cell walls (diderm) of gram-negative bacteria is critically essential to disrupting the biocatalysis, and to thereby kill the pathogen. Specific medium and short chain fatty acids have been identified as effective in creating the cellular disruption necessary for bacteriacidal efficacy. See Thormar, Halldor “Lipids and Essential Oils as Antimicrobial Agents” John Wiley and Sons 2-336 (2010).

### K. Temperature Instability of Specific Fatty Acids

While fatty acids, such as caprylic acid (octanoic acid) and lauric acid (dodecanoic acid), have proven efficacy in penetrating the cell wall of gram negative bacteria such as Salmonella and E. coli, the relative low-temperature instability of these fatty acids has limited their practice and use. Caprylic acid (octanoic acid) has a very high freezing point, approximately 8° C. (46° F.), where it becomes unstable, and crystalizes. See Burdock, George A. “Encyclopedia of Food and Color Additives” CRC Press 450-454 (1997); Watts, Henry “A dictionary of chemistry and the allied branches of other sciences” Longmans, Green, and co. 745-746 (1879). Since many food processors, especially poultry producers and beef processors, keep the internal temperatures of their factories between 38° F. and 45° F., similar to the low temperature freezing point of caprylic acid, it is impossible to apply caprylic acid directly in these locations without crystallization of the chemical. To overcome the obstacles presented by cold temperature facilities, food processors have adapted to use water-based esters of fatty acids, which are then combined with a water soluble organic acid to create protein washes to combat pathogenic gram negative and gram positive bacteria. However, water-based esters of fatty acids have limited efficacy, and cannot penetrate pathogens within lipids, fats, and oils.

### SUMMARY OF THE INVENTION

An antimicrobial composition within an antioxidant solution and used to protect a whole protein food source is provided. The antimicrobial compound of the composition is selected preferably from a medium chain fatty acid (MCFA), a long chain fatty acid (LCFA), a phenolic acid, and derivatives or mixtures thereof, and has a pH between about 2 and 6. Antioxidant compounds for the composition are composed preferably from phenolic based compounds such as butylated hydroxyanisole (BHA), butylated hydroxytoluene (butylhydroxytoluene, BHT), propyl gallate (propyl 3,4,5-trihydroxybenzoate), tert-butylhydroquinone (TBHQ, tertiary butylhydroquinone), mixed tocopherols (Tocopherols, Vitamin E), rosemary extract, oregano oil (origanum oil) and vegetable oil; other antioxidant compounds such as calcium propanoate (or calcium propionate) and ethoxyquin; and derivatives or mixtures thereof.

In accordance with the invention, the antimicrobial compound is contained within a solution of phenol-based antioxidants. The solution uses a delivery carrier liquid selected from water, and non-aqueous carriers chosen from vegetable oil, mixed tocopherols, propylene glycol, ethoxyquin, and mixtures thereof. Methods of use comprise contacting the inventive composition directly upon a surface, or mixing it within whole protein food sources.

### BRIEF DESCRIPTION OF THE DRAWINGS

FIG. 1 depicts a Data Table showing the results of a five day test using one formula of the invention.

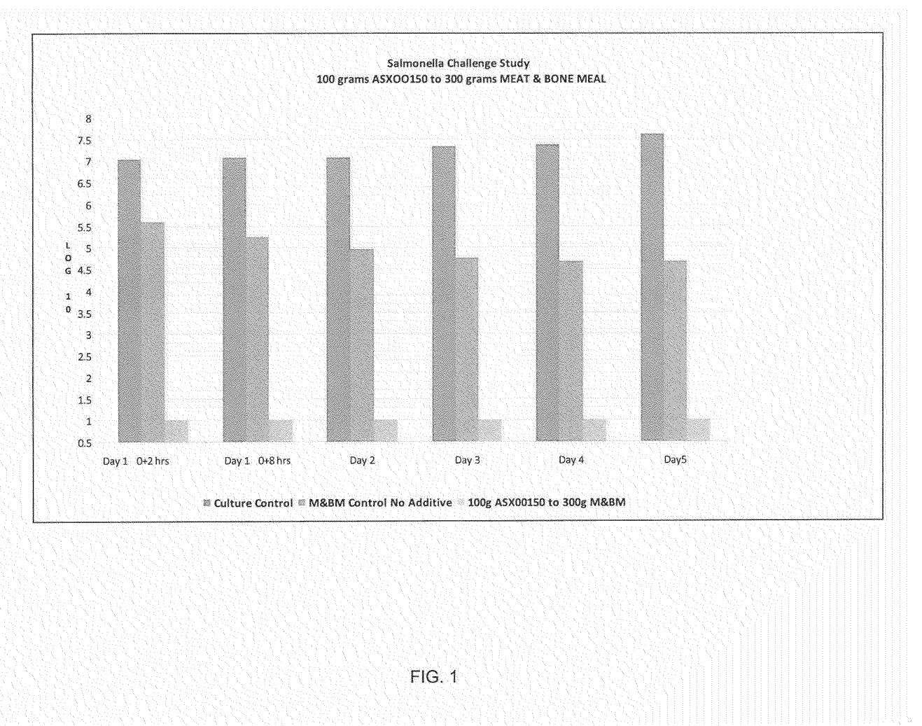

FIG. 2 depicts a Data Table showing the results of a five day test using a second formula of the invention.

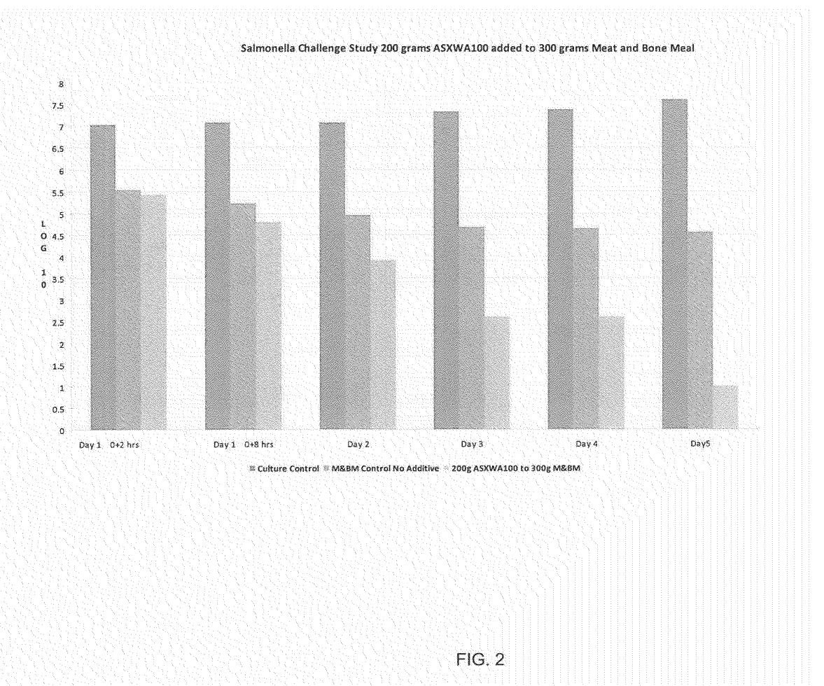

### DETAILED DESCRIPTION OF THE INVENTION

The inventive composition is prepared by mixing a solution that includes an antimicrobial agent prepared from the group consisting of a medium chain fatty acid (MCFA) such as caprylic acid (octanoic acid), a long chain fatty acid (LCFA) such as lauric acid (dodecanoic acid), a phenolic acid such as oregano oil (origanum oil), and derivatives or mixtures thereof, in an amount between 0.4% and 40% of the total weight of final formula. The purpose of the antimicrobial agent is for destroying or inhibiting the growth of food borne illness microbial pathogens.

The inventive composition also includes a stabilizing antioxidant chosen from phenolic compound powders or liquids such as butylated hydroxyanisole (BHA), butylated hydroxytoluene (butylhydroxytoluene, BHT), propyl gallate (propyl 3,4,5-trihydroxybenzoate), tert-butylhydroquinone (TBHQ, tertiary butylhydroquinone), calcium propanoate (or calcium propionate), from liquid phenolic compounds such as mixed tocopherols (tocopherols, Vitamin E), rosemary extract, the liquid phenolic acid oregano oil (origanum oil), vegetable oil, from the quinoline-based antioxidant liquid ethoxyquin, from the acid-based antioxidant calcium propanoate (or calcium propionate), and from derivatives or mixtures thereof. The antioxidant is present in an amount by weight of between 0.5% and 60% of the total weight of the final formula. The purpose of the antioxidant is for inhibiting oxidation of whole protein nutrient.

The inventive composition further includes a carrier liquid solution in an amount between 40% and 96% of the total weight of the final formula selected from water, and non-aqueous carriers chosen from mixed tocopherols, propylene glycol, ethoxyquin, vegetable oil (such as corn oil, soybean oil and canola oil), and derivatives or mixtures thereof. The inventive composition has the result of inhibiting the growth of microbial pathogens within the whole protein food source during application.

Preferred formula combinations would be:
1) Antimicrobial solution of medium chain fatty acid (MCFA) caprylic acid (octanoic acid) (between 1% and 25%), which may also include long chain fatty acid (LCFA) lauric acid (dodecanoic acid) (between 0% and 5%), phenolic acid oregano oil (origanum oil) (between 0% and 5%); with antioxidant solution of phenolic compounds powders butylated hydroxyanisole (BHA) (20%), butylated hydroxytoluene (butylhydroxytoluene, BHT) (20%); both within a carrier liquid of vegetable oil (between 35% and 57%).
2) Antimicrobial solution of medium chain fatty acid (MCFA) caprylic acid (octanoic acid) (1%-25%), which may also include long chain fatty acid (LCFA) lauric acid (dodecanoic acid) (0%-5%), phenolic acid oregano oil (origanum oil) (0%-5%), with antioxidant solution of phenolic compound powders butylated hydroxyanisole (BHA) (12%-13%), butylated hydroxytoluene (BHT) (12%-13%); and chelating agent stearyl citrate (1%-1.5%); both within a carrier liquid of vegetable oil (50%-73.5%).
3) Antimicrobial solution of medium chain fatty acid (MCFA) caprylic acid (octanoic acid) (1%-25%), which may also include long chain fatty acid (LCFA) lauric acid (dodecanoic acid) (0%-5%), phenolic acid oregano oil (origanum oil) (0%-5%), citric acid (10%); with antioxidant solution of phenolic compound powder tertiary butylhydroquinone (TBHQ) (20%), both within a carrier liquid of propylene glycol (45%-69%).
4) Antimicrobial solution of medium chain fatty acid (MCFA) caprylic acid (octanoic acid) (1%-25%), which may also include long chain fatty acid (LCFA) lauric acid (dodecanoic acid) (0%-5%), phenolic acid oregano oil (origanum oil) (0%-5%), citric acid (3%); with antioxidant solution of phenolic compound powder tertiary butylhydroquinone (TBHQ) (10%-20%); with emulsifying agent glyceryl monooleate (32%); both within a carrier liquid of propylene glycol (10%-15%) and vegetable oil (20%-30%).
5) Antimicrobial solution of medium chain fatty acid (MCFA) caprylic acid (octanoic acid) (1%-25%), which may also include long chain fatty acid (LCFA) lauric acid (dodecanoic acid) (0%-5%), phenolic acid oregano oil (origanum oil) (0%-5%), and citric acid (1%); with antioxidant solution phenolic compound powder tertiary butylhydroquinone (TBHQ) (10%-20%); with emulsifying agent glyceryl monooleate (32%); both within a carrier liquid of vegetable oil (25%-32%) and propylene glycol (7%-15%).
6) Antimicrobial solution of medium chain fatty acid (MCFA) caprylic acid (octanoic acid) (1%-25%), which may also include long chain fatty acid (LCFA) lauric acid (dodecanoic acid) (0%-5%), phenolic acid oregano oil (origanum oil) (0%-5%), and citric acid; with antioxidant solution of phenolic liquids mixed tocopherols (20%-30%), rosemary extract (1%); with emulsifying agents monodiglyceride and glycerin (5%); within a carrier liquid of vegetable oil (48%-63%).
7) Antimicrobial solution of medium chain fatty acid (MCFA) caprylic acid (octanoic acid) (1%-25%), which may also include long chain fatty acid (LCFA) lauric acid (dodecanoic acid) (0%-5%), phenolic acid oregano oil (origanum oil) (0%-5%), and triethyl citrate (23%-33%); with antioxidant solution liquid phenolic compound of ethoxyquin (51%-66%); within a carrier liquid of ethoxyquin (the ethoxyquin acts as a phenolic antioxidant and carrier).
8) Antimicrobial solution of medium chain fatty acid (MCFA) caprylic acid (octanoic acid) (1%-25%), which may also include long chain fatty acid (LCFA) lauric acid (dodecanoic acid) (0%-5%), phenolic acid oregano oil (origanum oil) (0%-5%); with antioxidant solution phenolic compound powder of tert-butylhydroquinone (TBHQ (5%-10%)); within a carrier liquid of ethoxyquin (10%-30%) and water (15%-20%).
9) Antimicrobial solution of medium chain fatty acid (MCFA) caprylic acid (octanoic acid) (1%-50%); within a carrier liquid vegetable oil (50%-99%) (the vegetable oil acts as a phenolic antioxidant and carrier).
10) Antimicrobial solution of medium chain fatty acid (MCFA) caprylic acid (octanoic acid) (1%-25%), which may also include long chain fatty acid (LCFA) lauric acid (dodecanoic acid) (0%-25%), phenolic acid oregano oil (origanum oil) (0%-25%); within a carrier liquid vegetable oil (75%-97%) (the vegetable oil acts as a phenolic antioxidant and carrier).

### Step by Step Preparation:

Step 1) Liquid carrier (either vegetable oils, such as corn oil, soybean oil and canola oil, propylene glycol or water) is delivered into stainless steel kettle mixing vessel, and heated by means of indirect heat (steam jacketing contact or hot water circulation through the outer surface of a vessel jacket that covers stainless steel kettle) until the liquid carrier reaches a temperature of not less than 65 degrees, but not greater than 85 degrees C. This creates optimum dissolution, yet the carrier is not damaged. For mixed tocopherols and ethoxyquin, the process of mixing is carried out without heating.

Step 2) After the carrier liquid has reached a desired temperature, powdered phenolic compounds (such as butylated hydroxyanisole (BHA), butylated hydroxytoluene (butylhydroxytoluene, BHT), propyl gallate (propyl 3,4,5-trihydroxybenzoate), tert-butylhydroquinone (TBHQ, tertiary butylhydroquinone), calcium propanoate (or calcium propionate), and/or liquid phenolic compounds such as mixed tocopherols (tocopherols, Vitamin E), vegetable oil, rosemary extract, and liquid phenolic acid oregano oil (origanum oil) are delivered into the preheated carrier. All ingredients are mixed together using a shear impeller driven at a speed that is appropriate to create dilution and for a time period of 60 minutes to 120 minutes, while keeping the liquid at temperature of between 65 degrees C and 85 degrees C. For mixed tocophenols and ethoxyquin, the process is carried out without heating.

Step 3) After 60 to 120 minutes, liquid antimicrobials chosen from: a medium chain fatty acid (MCFA) such as caprylic acid (octanoic acid), long chain fatty acid (LCFA) such as lauric acid (dodecanoic acid), a phenolic acid such as oregano oil (origanum oil), or a combination thereof are added. The step then continues to mix together using a shear impeller driven at a speed appropriate to create dilution for an additional time period of 45 minutes to 60 minutes, while maintaining the liquid at temperature of between 65 degrees C and 80 degrees C during this process.

### Data Table 1:

Chart 1 shows the results of a five day test using Formula 1 (identified as ASXOO150) when added to 300 grams of meat and bone meal. The study was performed in order to evaluate the performance of meat and bone meal enriched with nutrient that is treated with 100 grams of Formula 1. Two samples of meat and bone meal were tested and compared, one treated with Formula 1, and one control/untreated meat and bone meal. Both samples were contacted with 11 million count of Salmonella enterica bacteria, and measured over five days. The graph below compares the ‘Culture Control’, which measures the starting 11 million count Salmonella enterica control enriched with nutrient; the ‘M&BM control-no additive’, which is meat and bone meal without formula contacted with 11 million count Salmonella enterica; and the ‘100 g ASXOO150 to 300 g M&BM’, where 300 grams of meat and bone meal were mixed with 100 grams of ASXOO150 Formula 1 and then contacted with 11 million count Salmonella enterica.

### Data Table 2:

Chart 2 shows the results of a five day test using Formula 2 (identified as ASXWA100) when added to 300 grams of meat and bone meal. The study was performed in order to evaluate the performance of meat and bone meal enriched with nutrient that is treated with 100 grams of Formula 2. Two samples of meat and bone meal were tested and compared, one treated with Formula 2, and one control/untreated meat and bone meal. Both samples were contacted with 11 million count of Salmonella enterica bacteria, and measured over five days. The graph below compares the ‘Culture Control’, which measures the starting 11 million count Salmonella enterica control enriched with nutrient; the ‘M&BM control-no additive’, which is meat and bone meal without formula contacted with 11 million count Salmonella enterica; and the ‘100 g ASXWA100 to 300 g M&BM’, where 300 grams of meat and bone meal were mixed with 100 grams of ASXWA100 Formula 2 and then contacted with 11 million count Salmonella enterica.

### A. Animal Feeds

The inventive formula may be applied by mixing it within animal by product protein meal and meal sources (ruminant meat and bone meal, porcine/swine meat and bone meal, poultry by product meal, hydrolyzed feather meal) for the purpose achieving an antimicrobial bacteria static shield while preventing auto lipid oxidation.

### B. Poultry

The inventive formula may be applied by direct contact onto whole cuts of fresh poultry in order to achieve an antimicrobial-bacteria-static shield, while preventing auto-lipid oxidation.

The inventive formula may be applied by direct contact bath dipping with whole poultry carcass during processing or further processing in the production of poultry products in order to achieve an antimicrobial bacteria-static shield while preventing auto lipid oxidation.

The inventive formula may be applied by mixing it within ground poultry in order to achieve an antimicrobial bacteria-static shield while preventing auto lipid oxidation.

The inventive formula may be applied by mixing it within protein feed sources that are to be fed to poultry in order to achieve the reduction of pathogen expansion within the digestive tract of live poultry.

### C. Pet Food

The inventive formula may be applied by mixing it within feed and meal composition and pet food pre-mixes, both dry and soft forms of pet food sources, in order to achieve an antimicrobial bacteria-static shield upon the protein sources, while preventing auto lipid oxidation. The liquid product is added at the protein meal source, either prior to the heat extrusion process for a dry product, or prior to the cooking stage for a wet product. It is added by spraying it onto the wet protein source; this ensures that once the protein is made sterile by the application of heat, the protein source is shielded from further pathogenic contamination, while preventing auto lipid oxidation.

### D. Beef

The inventive formula may be applied by direct contact onto whole cuts of fresh beef muscle, which achieves an antimicrobial-bacteria static shield, while preventing auto-lipid oxidation.

The inventive formula may be applied by direct contact spray onto whole beef carcass and carcass segments during processing or further processing in the production of beef products, in order to achieve an antimicrobial bacteria static shield while preventing auto lipid oxidation.

The inventive formula may be applied by mixing it within ground beef, in order to achieve an antimicrobial bacteria static shield while preventing auto lipid oxidation.

The inventive formula may be applied by mixing it within protein feed sources that are to be fed to beef in order to achieve a reduction in pathogen expansion within the digestive tract of live beef cattle.

### E. Swine

The inventive formula may be applied by direct contact onto whole cuts of fresh pork or pork muscle, which achieve an antimicrobial-bacteria static shield, while preventing auto-lipid oxidation.

The inventive formula may be applied by direct contact spray onto whole pork carcass and carcass segments during processing or further processing in the production of pork products in order to achieve an antimicrobial bacteria static shield while preventing auto lipid oxidation.

The inventive formula may be applied by mixing it within ground pork, in order to achieve an antimicrobial bacteria static shield while preventing auto lipid oxidation.

The inventive formula may be applied by mixing it within protein feed sources that are to be fed to swine in order to achieve the reduction of pathogen expansion within the digestive tract of live swine.

### F. Prepared Foods

The inventive formula may be applied by including it within the protein meat source of any prepared food containing meat or meat products in order to achieve an antimicrobial bacteria static shield while preventing auto lipid oxidation.

The scope of the invention will be indicated in the claims.

1. A method of treating a protein food source such as poultry, beef and swine comprising the steps of:
(a) adding a phenolic antioxidant compound to a non-aqueous carrier liquid selected from the group consisting of vegetable oil, propylene glycol, mixed tocopherols, ethoxyquin and mixtures thereof.
(b) mixing together said carrier liquid and said antioxidant compound;
(c) adding an antimicrobial compound selected from the group consisting of a medium chain fatty acid (MCFA), a long chain fatty acid (LCFA), a phenolic acid, and derivatives or mixtures thereof;
(d) mixing together said carrier liquid, said antioxidant compound and said antimicrobial compound in order to form a non-aqueous antimicrobial composition; and
(e) delivering said antimicrobial composition to said protein food source.

2. The method of claim 1, wherein said delivering step is selected from the group of steps consisting of directly contacting said composition with said food source and mixing said composition with said food source.

3. The method of claim 1, wherein the antimicrobial compound is present in the composition in an amount between about 0.4 and 40 weight percent, the antioxidant compound is present in the composition in an amount between about 0.5 and 60 weight percent, and the carrier liquid is present in the composition in an amount between about 40 and 96 weight percent.

4. The method of claim 3, wherein the medium chain fatty acid is caprylic acid, the long chain fatty acid is lauric acid and the phenolic acid is oregano oil.

5. The method of claim 1, wherein the antioxidant compound is selected from the group consisting of butylated hydroxyanisole (BHA), butylated hydroxytoluene (butylhydroxytoluene, BHT), propyl gallate (propyl 3,4,5-trihydroxybenzoate), tert-butylhydroquinone (TBHQ, tertiary butylhydroquinone), mixed tocopherols (Tocopherols, Vitamin E), rosemary extract, oregano oil (origanum oil), vegetable oil, ethoxyquin, and derivatives or mixtures thereof.

6. The method of claim 1, wherein the medium chain fatty acid is caprylic acid, the long chain fatty acid is lauric acid and the phenolic acid is oregano oil.

7. A method of treating a protein food source such as poultry, beef and swine comprising the steps of:
(a) adding a phenolic antioxidant compound to a non-aqueous carrier liquid;
(b) mixing together said carrier liquid and said antioxidant compound;
(c) adding an antimicrobial compound selected from the group consisting of a medium chain fatty acid (MCFA), a long chain fatty acid (LCFA), a phenolic acid, and derivatives or mixtures thereof;
(d) mixing together said carrier liquid, said antioxidant compound and said antimicrobial compound in order to form a non-aqueous antimicrobial composition; and
(e) delivering said antimicrobial composition to said protein food source.

8. The method of claim 7, wherein said delivering step is selected from the group of steps consisting of directly contacting said composition with said food source and mixing said composition with said food source.

9. The method of claim 8, wherein the antimicrobial compound is present in the composition in an amount between about 0.4 and 40 weight percent, the antioxidant compound is present in the composition in an amount between about 0.5 and 60 weight percent, and the carrier liquid is present in the composition in an amount between about 40 and 96 weight percent.

10. The method of claim 7, wherein the medium chain fatty acid is caprylic acid, the long chain fatty acid is lauric acid and the phenolic acid is oregano oil.

11. The method of claim 10, wherein the antioxidant compound is selected from the group consisting of butylated hydroxyanisole (BHA), butylated hydroxytoluene (butylhydroxytoluene, BHT), propyl gallate (propyl 3,4,5-trihydroxybenzoate), tert-butylhydroquinone (TBHQ, tertiary butylhydroquinone), mixed tocopherols (Tocopherols, Vitamin E), rosemary extract, oregano oil (origanum oil), vegetable oil, ethoxyquin, and derivatives or mixtures thereof.

12. The method of claim 11, wherein the antimicrobial compound is present in the composition in an amount between about 0.4 and 40 weight percent, the antioxidant compound is present in the composition in an amount between about 0.5 and 60 weight percent, and the liquid carrier liquid is present in the composition in an amount between about 40 and 96 weight percent.

13. The method of claim 7, wherein the carrier liquid is selected from the group consisting of vegetable oil, propylene glycol, tocopherols, ethoxyquin and mixtures thereof.

14. The composition of claim 13, wherein the antimicrobial compound is present in the composition in an amount between about 0.4 and 40 weight percent, the antioxidant compound is present in the composition in an amount between about 0.5 and 60 weight percent, and the carrier liquid is present in the composition in an amount between about 40 and 96 weight percent.

15. A method of treating a protein food source comprising the steps of:
mixing together a non-aqueous carrier liquid, a phenolic antioxidant compound and an antimicrobial compound selected from the group consisting of a medium chain fatty acid (MCFA), a long chain fatty acid (LCFA), a phenolic acid, and derivatives or mixtures thereof; and
delivering said antimicrobial composition to said protein food source.

16. The method of claim 15, wherein said delivering step is selected from the group of steps consisting of directly contacting said composition with said food source and mixing said composition with said food source.

17. The method of claim 16, wherein the antimicrobial compound is present in the composition in an amount between about 0.4 and 40 weight percent, the antioxidant compound is present in the composition an amount between about 0.5 and 60 weight percent, and the carrier liquid is present in the composition in an amount between about 40 and 96 weight percent.

18. The method of claim 16, wherein the medium chain fatty acid is caprylic acid, the long chain fatty acid is lauric acid and the phenolic acid is oregano oil.

19. The method of claim 16, wherein the antioxidant compound is selected from the group consisting of butylated hydroxyanisole (BHA), butylated hydroxytoluene (butylhydroxytoluene, BHT), propyl gallate (propyl 3,4,5-trihydroxybenzoate), terl-butylhydroquinone (TBHQ, tertiary butylhydroquinone), mixed tocopherols (Tocopherols, Vitamin E), rosemary extract, oregano oil (origanum oil), vegetable oil, ethoxyquin, and derivatives or mixtures thereof.

20. The method of claim 16, wherein the carrier liquid is selected from the group consisting of vegetable oil, propylene glycol, tocopherols, ethoxyquin and mixtures thereof.
